(19) United States
(12) Patent Application Publication
(10) Pub. No.: US 2013/0279620 A1
(43) Pub. Date: Oct. 24, 2013

(54) METHODS OF TRANSMITTING COORDINATE MULTIPLE POINT DATA BASED ON ORTOGONAL COVERING CODES

(71) Applicants: Xiaobo Zhang, Shanghai (CN); Yan Zhao, Shanghai (CN)

(72) Inventors: Xiaobo Zhang, Shanghai (CN); Yan Zhao, Shanghai (CN)

(73) Assignee: ALCATEL LUCENT, Paris (FR)

(21) Appl. No.: 13/978,236

(22) PCT Filed: Jan. 3, 2012
(86) PCT No.: PCT/IB2012/000063

§ 371 Date: Jul. 3, 2013

(30) Foreign Application Priority Data
Jan. 6, 2011 (CN) 201110002068. X

(51) Int. Cl. H04B 7/02

(52) U.S. Cl. CPC H04B 7/024
USPC 375/267

(57) ABSTRACT

The present invention relates to methods of transmitting coordinate multiple point data based on orthogonal covering codes. In an embodiment of the present invention, there is provided a method of transmitting downlink data in a base station of a multiple input multiple output system. The method includes: A. determining a plurality of antenna groups from antennas of a plurality of coordinate multiple point cells; B. modulating inter-cell coordinate multiple point downlink data symbols for each antenna groups using different orthogonal covering codes. The orthogonal covering codes have a length not greater than twice the number of the antenna groups. With the methods of the present invention, a base station and a user equipment can distinguish signals from different coordinate multiple point cells, different antenna groups, or different coordinate multiple point clusters, reducing interference between signals from the different coordinate multiple point cells, the different antenna groups, or the different coordinate multiple point clusters.

### FIELD OF THE INVENTION

The present invention relates to wireless communication technologies, and more particularly, to methods of transmitting coordinate multiple point data in a multiple input multiple output system.

### BACKGROUND OF THE INVENTION

Coordinate multiple point (CoMP) has been proposed as a candidate technique for long term evolution-advanced (LTE-A) to improve edge users' experience. The major challenges of CoMP include backhaul latency, backhaul capacity, downlink channel state indicator (CSI), etc. Most of these challenges come from the motivation to coherently combine the transmitted signals of multiple cells at the user equipment (UE) side. In LTE-A, two CoMP solutions have been proposed. One is coordinated scheduling (CS) and the other is joint processing (JP).

A typical joint processing CoMP requires the UE to report the downlink CSI between itself and each of the CoMP cells, which can be represented as a KM×N matrix (K, M, N are cell number, antenna number per cell, and antenna number of the UE respectively). This kind of CSI feedback provides the possibility of global precoding at the evolved Node B (eNB) side. However, the feedback overhead and codebook search complexity may be too huge to be accepted.

A looser condition is to make the UE feedback an independent M×N matrix for each of the K cells and perform macro-diversity transmission. Several additional bits can be used to represent the inter-cell CSI phase/amplitude relationship, as introduced by some companies. The inter-cell feedback requires the UE to know the active CoMP set, which may influence scheduling complexity and result in too much feedback.

### SUMMARY OF THE INVENTION

Although existing downlink CoMP data transmission solutions have improved the spectrum efficiency of edge users, it is achieved at the cost of lower average spectrum efficiency since the edge users occupy more resources than they would do in a non-CoMP transmission case.

In order to partly or fully solve the above problem and improve the system performance, the present invention provides a solution for distinguishing antenna groups of CoMP cells, CoMP cells, or CoMP clusters using orthogonal covering codes (OCCs).

In an embodiment of the present invention, there is provided a method of transmitting downlink data in a base station of a multiple input multiple output system. The method includes: A. determining a plurality of antenna groups from antennas of a plurality of coordinate multiple point cells; B. modulating inter-cell coordinate multiple point downlink data symbols for each antenna groups using different orthogonal covering codes. The orthogonal covering codes have a length being not greater than twice the number of the antenna groups.

In another embodiment of the present invention, there is provided a method of transmitting downlink data in a base station of a multiple input multiple output system. The method includes: a. determining whether a user equipment is at an edge of a coordinate multiple point cluster; b. modulating downlink data symbols of the user equipment using an orthogonal covering code if the user equipment is at the edge of the coordinate multiple point cluster. And neighboring coordinate multiple point clusters use different orthogonal covering codes.

In yet another embodiment of the present invention, there is provided a method of transmitting uplink data in a user equipment of a multiple input multiple output system. The method includes: I. determining whether the user equipment is at an edge of a coordinate multiple point cell or a coordinate multiple point cluster; II. modulating uplink data symbols of the user equipment using an orthogonal covering code corresponding to the coordinate multiple point cell or the coordinate multiple point cluster if the user equipment is at the edge of the coordinate multiple point cell or the coordinate multiple point cluster. And neighboring coordinate multiple point cells or coordinate multiple point clusters correspond to different orthogonal covering codes.

With the methods of the present invention, a base station and a user equipment can distinguish signals from different coordinate multiple point cells, different antenna groups, or different coordinate multiple point clusters, according to t orthogonal covering codes, thereby reducing interference between signals from the different coordinate multiple point cells, the different antenna groups, or the different coordinate multiple point clusters. Each of the embodiments of the present invention partly or fully reaches the following technical effects: reducing requirements of coordinate multiple point data transmission for backhaul capacity and feedback overhead; keeping coherent combination gain.

### BRIEF DESCRIPTION OF THE DRAWINGS

Other features, objectives and advantages of the present invention will become more apparent after reading the following detailed description of non-limiting embodiments, with reference to the accompanying drawings, wherein below:

FIG. 1 is a flowchart illustrating a method of transmitting downlink data in a base station of a multiple input multiple output system according to an embodiment of the present invention;

FIGS. 2a and 2b illustrate an example of modulating data symbols using an orthogonal covering code respectively;

FIGS. 3a-3d are topologies illustrating downlink data transmission according to four different embodiments, respectively;

FIG. 4 is a flowchart illustrating a method of transmitting downlink data in a base station of a multiple input multiple output system according to another embodiment of the present invention;

FIG. 5 is a topology illustrating CoMP clusters according to an embodiment of the present invention;

FIG. 6 is a flowchart illustrating a method of transmitting uplink data in a user equipment of a multiple input multiple output system according to an embodiment of the present invention;

Identical or similar reference signs represent corresponding features throughout the drawings.

### DETAILED DESCRIPTION OF PREFERRED EMBODIMENTS

The methods of the present invention is adapted for cellular communication system, and more particularly, for an LTE or LTE-A system. The so-called “base station” in the present invention is, for example, but not limited to, a Node B or a eNB in an LTE or LTE-A system.

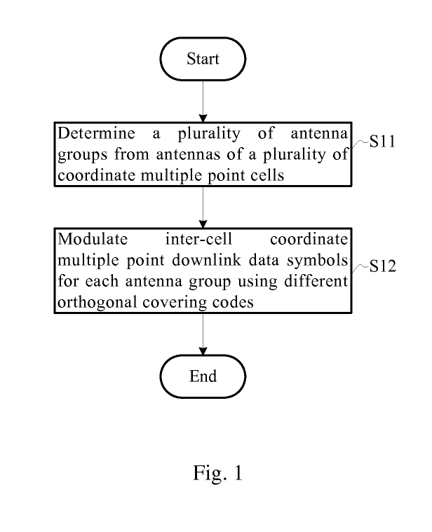

FIG. 1 is a flowchart illustrating a method of transmitting downlink data in a base station of a multiple input multiple output system according to an embodiment of the present invention. As shown, the method includes steps S11 and S12.

In step S11, the base station determines a plurality of antenna groups from antennas of a plurality of coordinate multiple point cells. For purposes of illustration instead of limitation, the plurality of coordinate multiple point cells pertains to the same coordinate multiple point cluster. Coordinate multiple point data is usually transmitted within a coordinate multiple point cluster. Advantageously, different antenna groups don't have an intersection set. There are different system settings for the antenna groups. An antenna group may include antennas of only one cell. For example, antennas of each cell compose an antenna group. An antenna group may also include antennas of multiple cells, and such an antenna group is an inter-cell antenna group. In step S11, the base station can determine the plurality of antenna groups according to a system setting.

In step S12, the base station modulates inter-cell coordinate multiple point downlink data symbols for each antenna group using different orthogonal covering codes. The orthogonal covering codes have a length being not greater than twice the number of the antenna groups. This can prevent channel distortion between data symbols modulated using an identical orthogonal covering code resulted from that the orthogonal covering code is too long. Optionally, the length of the orthogonal covering codes is equal to the number of the antenna groups, and the number of the orthogonal covering codes is equal to the number of the antenna groups.

The orthogonal covering codes may be Walsh code. A Walsh code is a binary sequence and usually has a length of an integer power of 2. A Walsh code with its length being 4 is represented as:

$$( \begin{matrix}1 & 1 & 1 & 1 \\ 1 & 1 & - 1 & - 1 \\ 1 & - 1 & 1 & - 1 \\ - 1 & 1 & 1 & - 1\end{matrix} ) .$$

The orthogonal covering codes may also be a complex value sequence, whose length needn't to be limited to an integer power of 2. For example, a Zad-off Chu code having a length of 3 may be used as an orthogonal covering code. The sequence can be represented as x(m)=exp(−jπm(m+1)/3), where m=[0 1 2],[1 2 0],[2 0 1].

The orthogonal covering codes can be mapped onto time domain, frequency domain, or time-frequency domain.

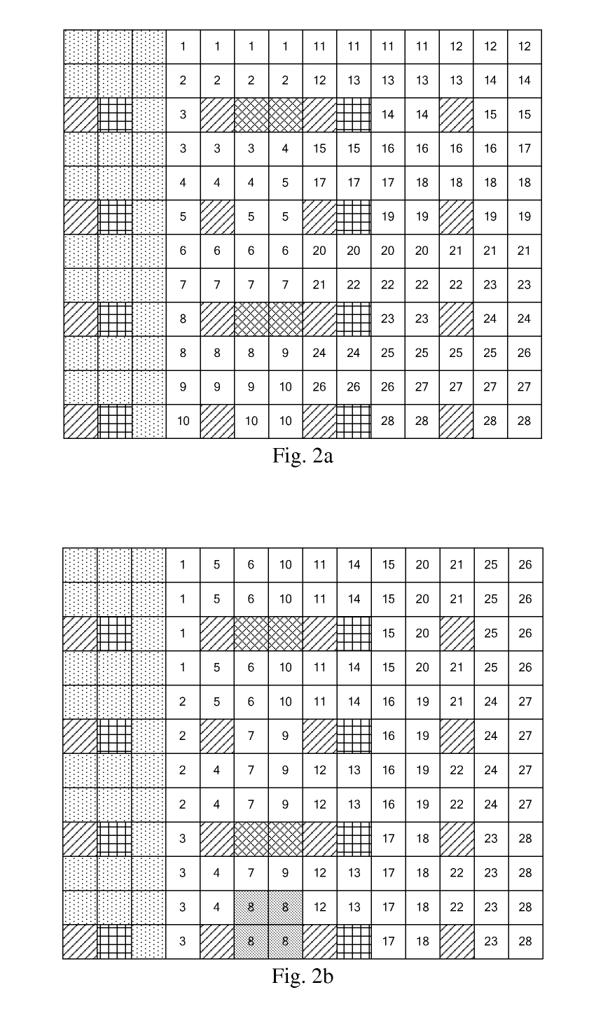

FIG. 2a illustrates an example of modulating data symbols using an orthogonal covering code. In this example, the length of the orthogonal covering code is 4, and only data symbols (DMRS symbols excluded) are modulated using the orthogonal covering code. In this figure, squares with identical signs represent symbols generated after a data symbol is modulated using an orthogonal covering code. As shown, four symbols are generated after each data symbol is modulated using an orthogonal covering code. Multiple modulated data symbols are mapped successively onto resource blocks allocated for these data symbols in a time-domain first and frequency-domain next order.

FIG. 2b illustrates another example of modulating data symbols using an orthogonal covering code. In this example, the length of the orthogonal covering code is 4, and only data symbols (DMRS symbols excluded) are modulated using the orthogonal covering code. In this figure, squares with identical signs represent symbols generated after a data symbol is modulated using an orthogonal covering code. As shown, four symbols are generated after each data symbol is modulated using an orthogonal covering code. Multiple modulated data symbols are mapped successively onto resource blocks allocated for these data symbols in a frequency-domain first and time-domain next “Z” order, which makes symbols generated after modulating the same data symbol close to each other in the frequency domain, thus will not experience significant frequency response distortion, as shown by the square denoted with 8 in the figure.

In the above two examples, when the number of resource elements for the data symbols in the allocated resource blocks is not an integer times of 4, the remaining resource elements after an integer number of data symbols have been mapped may be processed by puncturing or rate-matching.

After modulation using orthogonal covering codes, the user equipment can distinguish downlink data from different antenna groups, thereby improving the receiver performance.

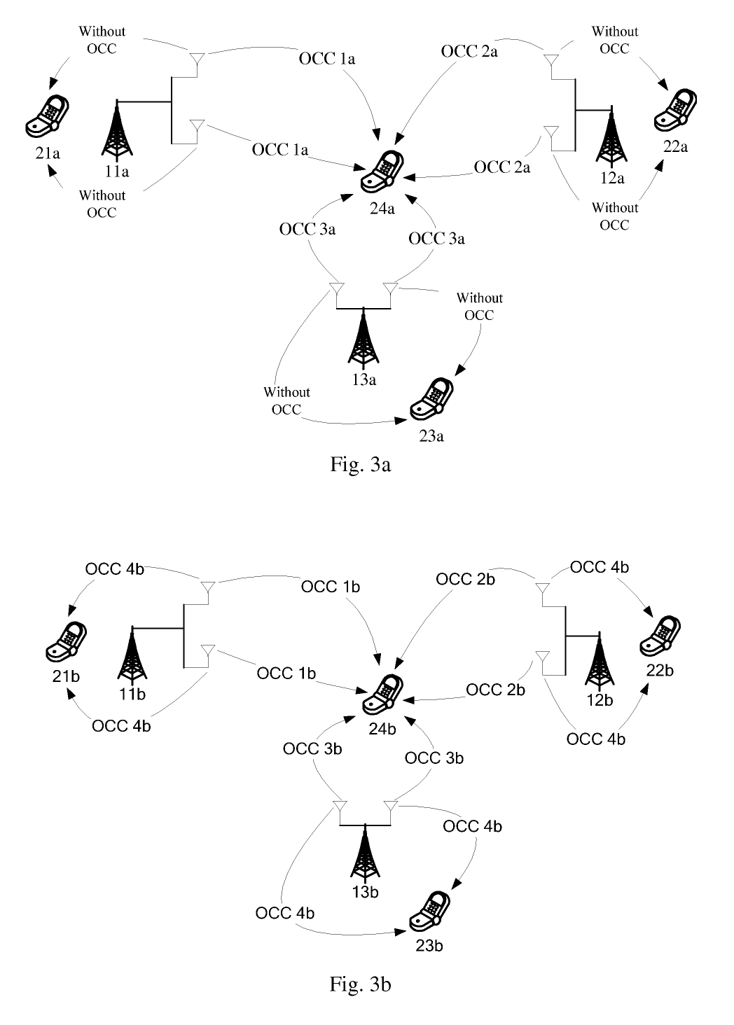

FIG. 3a is a topology illustrating downlink data transmission according to an embodiment of the present invention. As shown, cells 11a, 12a, and 13a pertain to the same coordinate multiple point cluster. For example, the cells 11a, 12a, and 13a may be three sectors under the control of the same eNB. The system setting in the example is configured such that antennas of each cell compose an antenna group. Thus the coordinate multiple point cluster consisting of the cells 11a, 12a, and 13a includes three antenna groups.

In step S11, the base station determines the three antenna groups according to the system setting.

The user equipment 24a shown in the figure enjoys inter-cell coordinate multiple point downlink transmission service. In step 12, the base station transmits different inter-cell coordinate multiple point downlink data symbols to an identical inter-cell coordinate multiple point user equipment 24a via the antenna groups of the cells 11a, 12a, and 13a. Wherein, the inter-cell coordinate multiple point downlink data symbols transmitted by the antenna group of the cell 11a to the user equipment 24a are modulated using an orthogonal covering code 1a, the inter-cell coordinate multiple point downlink data symbols transmitted by the antenna group of the cell 12a to the user equipment 24a are modulated using an orthogonal covering code 2a, and the inter-cell coordinate multiple point downlink data symbols transmitted by the antenna group of the cell 13a to the user equipment 24a are modulated using an orthogonal covering code 3a. Preferably, in this example Zad-off Chu codes of length 3 are used as orthogonal covering codes. Downlink data symbols transmitted from the three cells to the user equipment are modulated using different codes and there is good orthogonality between them. Therefore, the user equipment 24a is able to distinguish data symbols from different antenna groups. Although code rate from each antenna after orthogonal covering code modulation is around ⅓, what each antenna group transmits to the user equipment 24a are different downlink data symbols. Therefore, overall downlink data rate received by the user equipment 24a is not decreased. Furthermore, when the user equipment 24a orthogonal covering code demodulates received signals from each antenna group, the gain achieved by symbol combination is comparable to coherent combination gain in conventional coordinate multiple point downlink transmission.

In this example, the base station doesn't modulate downlink data symbols for non-CoMP user equipments (e.g., user equipments 21a, 22a, and 23a) in each cell using orthogonal covering codes. Taking into account received power gain due to orthogonal covering code modulation (similar to spreading modulation), the base station may allocate less power for downlink data of a coordinate multiple point user equipment, and thus an increased average throughput is achieved. In a case where a user equipment doesn't feedback CSI between cells, the method in the example could still be applied without being influenced and requirements for backhaul capacity and feedback overhead are lowered at the same time.

FIG. 3b is a topology illustrating downlink data transmission according to an embodiment of the present invention. As shown, cells 11b, 12b, and 13b pertain to the same coordinate multiple point cluster. For example, the cells 11b, 12b, and 13b may be three sectors under the control of the same eNB. The system setting in the example is configured such that antennas of each cell compose an antenna group. Thus the coordinate multiple point cluster consisting of the cells 11b, 12b, and 13b includes three antenna groups.

In step S11, the base station determines the three antenna groups according to the system setting.

The user equipment 24b shown in the figure enjoys inter-cell coordinate multiple point downlink transmission service. In step 12, the base station transmits different inter-cell coordinate multiple point downlink data symbols to an identical inter-cell coordinate multiple point user equipment 24b via the antenna groups of the cells 11b, 12b, and 13b. Wherein, the inter-cell coordinate multiple point downlink data symbols transmitted by the antenna groups of the cells 11b, 12b, and 13b to the user equipment 24a are modulated using orthogonal covering codes 1b, 2b, and 3b, respectively.

In step S12, the base station modulates inner-cell downlink symbols for each antenna group using an orthogonal covering code different from the one used for modulating inter-cell coordinate multiple point downlink symbols for the antenna group. As shown, the base station modulates downlink data symbols of user equipments 21b, 22b, and 23b with an orthogonal covering code 4b. This manner is suitable for a case where a cell doesn't know CSI between itself and a user equipment. For example, the cell 11b may distinguish downlink data symbols transmitted to the inter-cell coordinate multiple point user equipment 24b and those transmitted to the inner-cell user equipment 21b using the orthogonal covering codes 1b and 4b. In this way, the antenna resources are sufficiently utilized and the number of users served by each cell is increased. When a user equipment doesn't report CSI between itself and a cell, requirements for backhaul capacity and feedback overhead are lowered.

Alternatively, the base station may modulate downlink data symbols of the user equipment 21b using the orthogonal covering code 2b or 3b, modulate those of the user equipment 22b using the orthogonal covering code 3b or 1b, and modulate those of the user equipment 23b using the orthogonal covering code 1b or 2b. In this way, code resources are sufficiently utilized and average throughput of the system is increased.

FIG. 3c is a topology illustrating downlink data transmission according to an embodiment of the present invention. As shown, cells 11c, 12c, and 13c pertain to the same coordinate multiple point cluster. For example, the cells 11c, 12c, and 13c may be three sectors under the control of the same eNB. The system setting in the example is configured such that antennas of each cell compose an antenna group. Thus the coordinate multiple point cluster consisting of the cells 11c, 12c, and 13c includes three antenna groups.

In step S11, the base station determines the three antenna groups according to the system setting.

In step S12, the base station transmits downlink data symbols to different user equipments via each antenna group. As shown, the base station transmits downlink data symbols to a user equipment 21c via an antenna group of the cell 11c and performs modulation using an orthogonal covering code 1c, transmits downlink data symbols to a user equipment 22c via an antenna group of the cell 12c and performs modulation using an orthogonal covering code 2c, and transmits downlink data symbols to a user equipment 23c via an antenna group of the cell 13c and performs modulation using an orthogonal covering code 3c. In this way, downlink data of neighboring cells are modulated using different orthogonal covering codes, and inter-cell interference is removed after the receiver terminals (the user equipments) perform orthogonal covering code demodulation.

FIG. 3d is a topology illustrating downlink data transmission according to an embodiment of the present invention. As shown, cells 11d, 12d, and 13d pertain to the same coordinate multiple point cluster. For example, the cells 11d, 12d, and 13d may be three sectors under the control of the same eNB. The system setting in this example is configured such that each cell contributes one antenna to compose an inter-cell antenna group (in a cross polarization case, each cell contributes one pair of antennas to compose an inter-cell antenna group). As shown, each cell has two antennas. Therefore, the coordinate multiple cluster consisting of the cells 11d, 12d, and 13d includes two inter-cell antenna groups.

In step S11, the base station determines the two inter-cell antenna groups according to the system setting.

In step S12, the base station transmits inter-cell coordinate multiple point downlink data symbols to at least one inter-cell coordinate multiple point user equipment via the at least one inter-cell antenna group. The user equipments 21d and 22d shown in the figure enjoys inter-cell coordinate multiple point downlink transmission service. Accordingly, in step S12, the base station transmits inter-cell coordinate multiple point downlink data symbols to the inter-cell coordinate multiple point user equipment 21d via a first inter-cell antenna group and performs modulation using an orthogonal covering code 1d, and transmits inter-cell coordinate multiple point downlink data symbols to the inter-cell coordinate multiple point user equipment 22d via a second inter-cell antenna group and performs modulation using an orthogonal covering code 2d. Wherein, the antennas in each inter-cell antenna group transmit the same data symbols. The inter-cell coordinate multiple point user equipments 21d and 22d should report their respective CSI between themselves and each of the three cells 11d, 12d, and 13d to facilitate precoding for the two inter-cell antenna groups. Because in this example the coordinate multiple point cluster consisting of the cells 11d, 12d, and 13d includes two inter-cell antenna groups, the orthogonal covering codes 1d and 2d may be Walsh code having a length of 2. Because antennas from different cells are less correlated, better spatial gain could be achieved by downlink data transmission via an inter-cell antenna group. Moreover, when the user equipments 21d and 22d demodulate downlink data signals received from the inter-cell antenna groups, coherent combination gain is still available. Whether the multiple inter-cell antenna groups serve one or more user equipments depends on scheduling capability of the base station and performance of the user equipments. The method in this example is suitable for coordinate multiple point downlink data transmission among multiple cells under the control of an identical base station, because these cells can exchange CSI, other control information, signaling information, and data, etc., via buses or other wired interfaces. Therefore, unfavorable impact of excessive latency on inter-cell coordinate multiple point downlink data transmission is avoided.

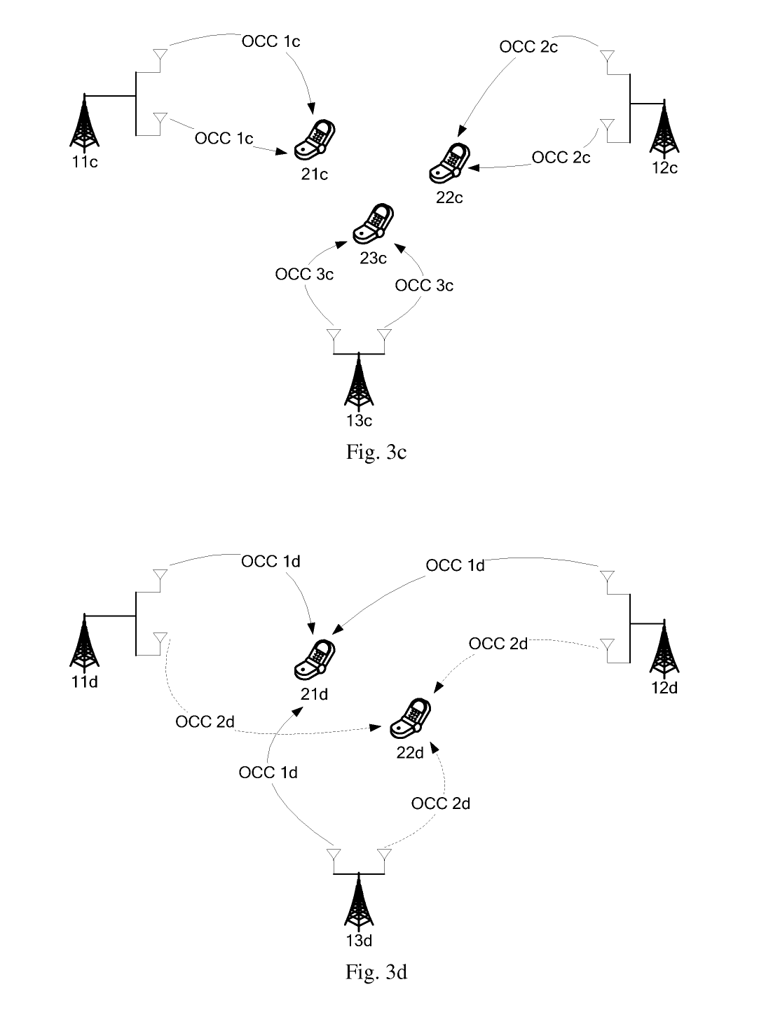

FIG. 4 is a flowchart illustrating a method of transmitting downlink data in a base station of a multiple input multiple output system according to another embodiment of the present invention. As shown, the method includes steps S41 and S42.

In step S41, the base station determines whether a user equipment is at an edge of a coordinate multiple point cluster.

Specifically, the base station may make the determination according to a CQI report or a received power of a positioning reference signal fed back from the user equipment. When the value of the CQI fed back from the user equipment is lower than a predetermined value, which indicates that channel quality between the user equipment and the base station is bad, the base station determines that the user equipment is at the edge of the coordinate multiple point cluster. Alternatively, when the received power of the positioning reference signal fed back from the user equipment is lower than a predetermined value, which indicates that the user equipment is far away from the base station, the base station determines that the user equipment is at the edge of the coordinate multiple point cluster.

In step S42, the base station modulates downlink data symbols of the user equipment using an orthogonal covering code if the user equipment is at the edge of the coordinate multiple point cluster. And neighboring coordinate multiple point clusters use different orthogonal covering codes.

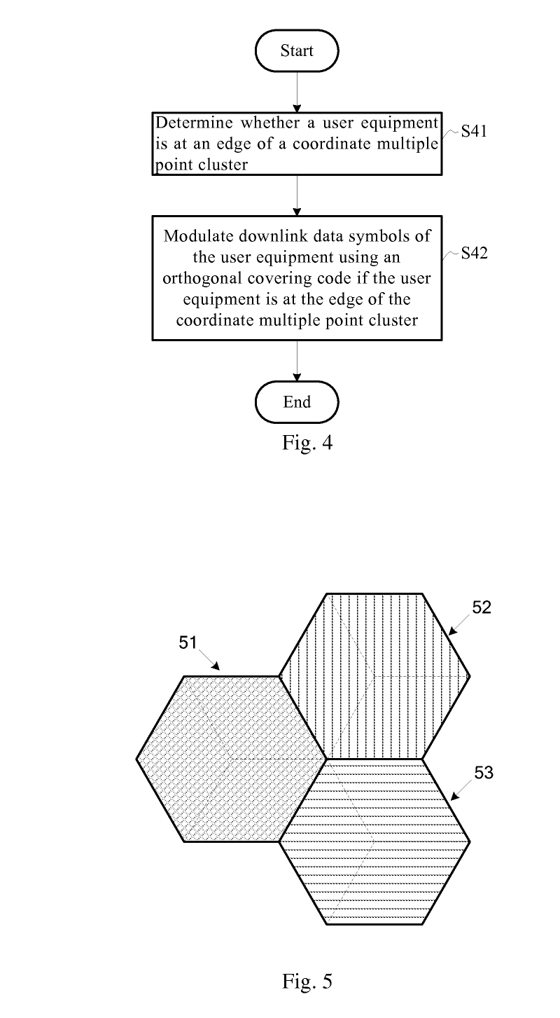

FIG. 5 is a topology illustrating CoMP clusters according to an embodiment of the present invention. The figure illustrates three neighboring CoMP clusters 51, 52, and 53 each including three cells (sectors). Referring to step S42 above, the three neighboring CoMP clusters 51, 52, and 53 employ different orthogonal covering codes, respectively. In this way, a user equipment at the edge of a cluster can distinguish signals from different clusters after demodulating received signals using orthogonal covering codes, thereby reducing downlink data interference between neighboring clusters. As shown in FIG. 5, in this embodiment, if all CoMP clusters are configured in a manner similar to that with the clusters 51, 52, and 53, the multiple input multiple output system needs at least only three orthogonal covering codes that are mutually orthogonal.

Similar to the embodiment described above in connection with FIG. 1, the orthogonal covering codes may be Walsh code or Zad-off Chu code.

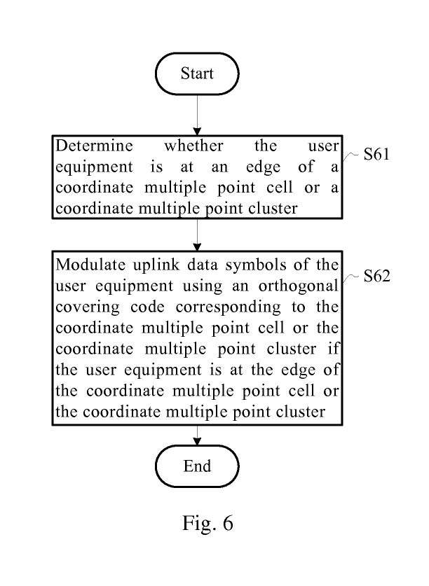

FIG. 6 is a flowchart illustrating a method of transmitting uplink data in a user equipment of a multiple input multiple output system according to an embodiment of the present invention. As shown, the method includes steps S61 and S62.

In step S61, the user equipment determines whether the user equipment is at an edge of a coordinate multiple point cell or a coordinate multiple point cluster.

Specifically, the user equipment may make the determination according to a CQI or a received power of a positioning reference signal. When the value of the CQI is lower than a predetermined value, which indicates that channel quality between the user equipment and a base station is bad, the user equipment determines that it is at the edge of the coordinate multiple point cell or the coordinate multiple point cluster. Alternatively, when the power of the positioning reference signal received by the user equipment is lower than a predetermined value, which indicates that the user equipment is far away from the base station, the user equipment determines that it is at the edge of the coordinate multiple point cell or the coordinate multiple point cluster.

In step S61, the user equipment modulates its uplink data symbols using an orthogonal covering code corresponding to the coordinate multiple point cell or the coordinate multiple point cluster if the user equipment is at the edge of the coordinate multiple point cell or the coordinate multiple point cluster. And neighboring coordinate multiple point cells or coordinate multiple point clusters correspond to different orthogonal covering codes.

In this example, the coordinate multiple point cells or the coordinate multiple point clusters in the system may employ, for example, the topology shown in FIG. 5. FIG. 5 illustrates three neighboring CoMP clusters 51, 52, and 53 each including three cells (sectors). Referring to step S62 above, the three neighboring CoMP clusters 51, 52, and 53 correspond to different orthogonal covering codes, respectively. In this way, a user equipment at the edge of a cluster modulates its uplink data symbols using an orthogonal covering code corresponding to the coordinate multiple point cell or the coordinate multiple point cluster. The base station can distinguish signals from user equipments of different cells or clusters after demodulating received signals with orthogonal covering codes, thereby reducing uplink data interference between neighboring clusters. As shown in FIG. 5, in this embodiment, if all CoMP clusters are configured in a manner similar to that with the clusters 51, 52, and 53, the multiple input multiple output system needs at least only three orthogonal covering codes that are mutually orthogonal.

Similar to the embodiment described above in connection with FIG. 1, the orthogonal covering codes may be a Walsh code or a Zad-off Chu code.

In various embodiments of the present invention, the impact due to interference from edge users in data symbols modulated using an orthogonal covering code is much severer than that due to channel variation, and symbol combination gain resulting from orthogonal covering code demodulation of received signals should overwhelm errors resulting from channel variation.

A person skilled in the art would understand that the above embodiments are exemplary rather than limiting. And different technical features in different embodiments may be combined to achieve desirable effects. Modified embodiments other than the disclosed embodiments may be understood and implemented by a person skilled in the art in light of the accompanying drawings, the specification and the appended claims. In the claims, any form of the term “comprise” doesn't exclude other devices or steps; the indefinite article “a” or “an” isn't intended to mean singular number; and the terms “first” or “second” serves to identify names rather than to indicate any particular order. Any reference signs in the claims cannot be construed to be a limiting to the scope of the claims. And the functions of several parts in a claim may be implemented with a single hardware or software module. The mere fact that certain technical features exist in different dependent claims isn't intended to exclude the possibility that these technical features may be combined to achieve desirable effects.

1. A method of transmitting downlink data in a base station of a multiple input multiple output system, the method comprising:
determining a plurality of antenna groups from antennas of a plurality of coordinate multiple point cells;
modulating inter-cell coordinate multiple point downlink data symbols for each antenna group using different orthogonal covering codes respectively;
wherein the orthogonal covering codes have a length being not greater than twice the number of the antenna groups.

2. A method of claim 1, wherein each antenna group determined includes antennas of only one cell; and
modulating inter-cell coordinate multiple point downlink data symbols for each antenna group using different orthogonal covering codes respectively further comprises transmitting different inter-cell coordinate multiple point downlink data symbols to an identical inter-cell coordinate multiple point user equipment via each antenna group.

3. A method of claim 2, wherein modulating inter-cell coordinate multiple point downlink data symbols for each antenna group using different orthogonal covering codes respectively further comprises modulating inner-cell downlink symbols for each antenna group using an orthogonal covering code different from the one used for modulating inter-cell coordinate multiple point downlink symbols for the antenna group.

4. A method of claim 1, wherein each antenna group determined includes antennas of only one cell; and modulating inter-cell coordinate multiple point downlink data symbols for each antenna group using different orthogonal covering codes respectively further comprises transmitting downlink data symbols to different user equipments via each antenna group.

5. A method of claim 1, wherein at least one inter-cell antenna group comprising antennas of multiple cells is determined; and
modulating inter-cell coordinate multiple point downlink data symbols for each antenna group using different orthogonal covering codes respectively further comprises transmitting inter-cell coordinate multiple point downlink data symbols to at least one inter-cell coordinate multiple point user equipment via the at least one inter-cell antenna group.

6. A method of claim 1, wherein the length of the orthogonal covering codes is equal to the number of the antenna groups.

7. A method of claim 1, wherein the orthogonal covering codes comprise Walsh codes or Zad-off Chu codes.

8. A method of transmitting downlink data in a base station of a multiple input multiple output system, the method comprising:
determining whether a user equipment is at an edge of a coordinate multiple point cluster;
modulating downlink data symbols of the user equipment using an orthogonal covering code if the user equipment is at the edge of the coordinate multiple point cluster;
wherein neighboring coordinate multiple point clusters use different orthogonal covering codes.

9. A method of claim 8, wherein in the determining whether a user equipment is at an edge of a coordinate multiple point cluster, whether the user equipment is at the edge of the coordinate multiple point cluster is determined according to a positioning reference signal or a CQI report.

10. A method of claim 8, wherein the orthogonal covering codes comprise Walsh code or Zad-off Chu code.

11. A method of transmitting uplink data in a user equipment of a multiple input multiple output system, the method comprising:
determining whether the user equipment is at an edge of a coordinate multiple point cell or a coordinate multiple point cluster;
modulating uplink data symbols of the user equipment using an orthogonal covering code corresponding to the coordinate multiple point cell or the coordinate multiple point cluster if the user equipment is at the edge of the coordinate multiple point cell or the coordinate multiple point cluster;
wherein neighboring coordinate multiple point cells or coordinate multiple point clusters correspond to different orthogonal covering codes.

12. A method of claim 11, wherein in the determining whether the user equipment is at an edge of a coordinate multiple point cell or a coordinate multiple point cluster, whether the user equipment is at the coordinate multiple point cell or the coordinate multiple point cluster is determined according to a positioning reference signal or a CQI report.

13. A method of claim 11, wherein the orthogonal covering codes comprise Walsh code or Zad-off Chu code.
